(19) United States
(12) Patent Application Publication
(10) Pub. No.: US 2025/0303588 A1
(43) Pub. Date: Oct. 2, 2025

(54) ROBOTIC FINGERS WITH ACTUATING JOINTS

(71) Applicant: Tacta Systems Inc., Palo Alto, CA (US)

(72) Inventors: Justin W. Mauck, Belmont, CA (US); Dariusz Golda, Portola Valley, CA (US); Andreas Bibl, Los Altos, CA (US)

(21) Appl. No.: 18/620,643

(22) Filed: Mar. 28, 2024

(51) Int. Cl. B25J 15/12; B25J 15/00

(52) U.S. Cl. CPC B25J 15/12; B25J 15/0009

(57) ABSTRACT

A system for a robotic finger may include a base coupled with a robotic finger having a plurality of joints and an actuation system that actuates the plurality of joints. The actuation system may include a first actuator that drives a connection coupled with a first joint of the plurality of joints. Driving the connection can cause a first rotation of the robotic finger about a first axis. The actuation system may also include a second actuator that drives a cylinder coupled with the first joint. Driving the cylinder can cause a second rotation of the robotic finger about a second axis. The cylinder can rotate freely about the first axis to enable the first rotation. Other aspects are also described and claimed.

### BACKGROUND

### Field

This disclosure relates generally to robotic control and, more specifically, to robotic fingers with actuating joints. Other aspects are also described.

### Background Information

A robotic device, or robot, may refer to a machine that can automatically perform one or more actions or tasks in an environment. For example, a robotic device could be configured to assist with manufacturing, assembly, packaging, maintenance, cleaning, transportation, exploration, surgery, or safety protocols, among other things. A robotic device can include various mechanical components, such as a robotic arm and an end effector, to interact with the surrounding environment and to perform the tasks. A robotic device can also include a processor or controller executing instructions stored in memory to configure the robotic device to perform the tasks.

### SUMMARY

Implementations of this disclosure include utilizing an actuation system to control joints of robotic fingers of a robotic hand to enable performance of complex motions consistent with motions of the human hand (an anthropomorphic robotic hand). For example, the motions may include abduction, adduction, flexion, and/or extension at various joints of the robotic fingers, including simultaneously performed combinations thereof. In some implementations, a system for a robotic finger may include a base (e.g., a robotic hand) coupled with a robotic finger having a plurality of joints and an actuation system that actuates the plurality of joints. The actuation system may include a first actuator that drives a connection coupled with a first joint of the plurality of joints. Driving the connection can cause a first rotation of the robotic finger about a first axis (e.g., flexion or extension of the robotic finger at the first joint, such as moving the finger up and down). The actuation system may also include a second actuator that drives a cylinder coupled with the first joint. Driving the cylinder can cause a second rotation of the robotic finger about a second axis (e.g., abduction or adduction of the robotic finger at the first joint, such as moving the finger from side to side). The cylinder can rotate freely about the first axis to enable the first rotation, including while driven to cause the second rotation. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure herein are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system utilizing robotic fingers with actuating joints.

FIG. 2 is an example of robotic fingers with tactile sensing.

FIG. 3 is an example of a cross-section of a portion of a robotic finger.

FIG. 4 is an isometric view of an example of a robotic finger.

FIG. 5 is a top view of an example of a robotic finger.

FIG. 6 is a side view of an example of a robotic finger.

FIG. 7 is an example of an actuation system that actuates joints of a robotic finger.

FIG. 8 is an example of a first rotation of a robotic finger at a first joint.

FIG. 9 is a cutaway view of a portion of a robotic finger at a first joint.

FIG. 10 is an example of a second rotation of a robotic finger at a first joint.

FIG. 11 is an example of multiple rotations of a robotic finger at multiple joints.

FIG. 12 is an example of a process for operating robotic fingers with actuating joints.

FIG. 13 is an isometric view of an example of a compliance device for a robotic finger.

FIG. 14 is a cutaway view of an example of a compliance device for a robotic finger.

FIG. 15 is a cutaway view of another example of a compliance device for a robotic finger.

### DETAILED DESCRIPTION

A human hand can perform many complex motions. For example, each finger of the human hand includes a metacarpophalangeal (MCP) joint, a proximal interphalangeal (PIP) joint, and a distal interphalangeal (DIP) joint, which together enable at least three degrees of freedom (DOF). The thumb also includes an interphalangeal (IP) joint and an MCP joint enabling an additional four DOF. Together, these joints enable possible many motions, such as abduction (e.g., outward movement of the finger at the MCP joint, away from the midline), adduction (e.g., inward movement of the finger at the MCP joint, toward the midline), flexion (e.g., downward movement of the finger at the MCP, DIP, and/or PIP joints), extension (e.g., upward movement of the finger at the MCP, DIP, and/or PIP joints), opposition (e.g., curling of the fingers and thumb to touch one another), and reposition (e.g., straightening of the fingers and thumb to the midline).

A human hand also has the strength to perform many tasks, such as lifting a heavy object or grasping an object by pinching a finger and a thumb together (e.g., applying 10 to 20 Newtons of force). Moreover, the human hand can perform complex motions with strength by utilizing larger muscles and tendons in the arm.

Existing robotic hands which attempt to replicate the motions and strength of the human hand typically suffer from deficiencies. For example, while some robotic hands can perform flexion/extension motions of a finger at the MCP joint, they typically must perform abduction/adduction motions further down the finger (e.g., halfway between the MCP joint and the PIP joint). This may result in movements that are inconsistent with the human hand. Also, to achieve strength, many robotic hands are significantly larger than the range of dimensions of a human hand. For example, they are typically oversized to accommodate motors, hydraulics, actuators, and the like in the fingers of the robotic hand to enable the equivalent strength of a human hand. Those that are reduced in size (e.g., closer to dimensions of a human hand) typically lack the power to perform basic functions, such as using a wrench to turn a screw as opposed to merely holding the wrench.

Many existing robotic hands are also difficult to maintain or repair. For example, when they include hydraulics, they often have lines that are subject to bending and breaking at various downstream joints in the finger. These robotic hands are typically expensive and often not suitable for repair, often requiring full replacement when breakage occurs.

Implementations of this disclosure address problems such as these by utilizing an actuation system to control joints of robotic fingers of a robotic hand (e.g., MCP, PIP, and DIP joints) to enable performance of complex motions consistent with motions of the human hand (an anthropomorphic robotic hand). For example, the motions may include abduction, adduction, flexion, and/or extension at various joints of the robotic fingers, including simultaneously performed combinations thereof (e.g., extension at the same time as adduction or abduction, or flexion at the same time as adduction or abduction).

In some implementations, a system for a robotic finger may include a base (e.g., a robotic hand) coupled with one or more robotic fingers (e.g., two fingers of a pinch gripper, or four fingers and a robotic thumb of the robotic hand), each having a plurality of joints, and an actuation system (e.g., a hydraulic, pneumatic, piezoelectric, or motor drive system, or combination thereof) that actuates the plurality of joints. The actuation system may include a first actuator that drives a connection coupled with a first joint of the plurality of joints (e.g., an MCP joint). Driving the connection can cause a first rotation of the robotic finger about a first axis (e.g., flexion or extension of the robotic finger at the MCP joint, such as moving the robotic finger up and down). The actuation system may also include a second actuator that drives a cylinder coupled with the first joint (e.g., the MCP joint). Driving the cylinder can cause a second rotation of the robotic finger about a second axis (e.g., abduction or adduction of the robotic finger at the MCP joint, such as moving the robotic finger from side to side). The cylinder can rotate freely about the first axis to enable the first rotation, including while driven to cause the second rotation.

The actuation system may also include a third actuator that drives a second connection coupled with a second joint of the plurality of joints (e.g., a PIP joint). Driving the second connection can cause a third rotation of the robotic finger about a third axis (e.g., flexion or extension of the robotic finger at the PIP joint, such as moving the robotic finger up and down). Further, driving the second connection can cause a fourth rotation of the robotic finger about a fourth axis corresponding to a third joint of the plurality of joints (e.g., flexion or extension of the robotic finger at a DIP joint, such as moving a robotic fingertip up and down). As a result, robotic fingers of a robotic hand can perform motions that are consistent with motions of a human fingers of a human hand, including abduction, adduction, flexion, and/or extension at various joints, and simultaneous combinations thereof.

In some implementations, each robotic finger of a robotic hand may enable actuating an MCP joint with a simultaneous coordinated abduction/adduction motion and extension/flexion motion. In some cases, the actuations may be performed with pressurized hydraulics, pneumatics, motors, and/or linear actuation. In some cases, one or more of the actuations may be dual acting (e.g., a linkage to push and pull, such as to perform flexion and extension of the robotic finger, respectively). In some cases, one or more of the actuations may be single acting with a spring return (e.g., a tendon to pull the robotic finger down to perform flexion and a spring to return the robotic finger to extension).

In some implementations, positional feedback may be obtained from the actuation system to determine angles of rotation at various joints. This may enable precise control of such angles via the actuation system. For example, positional feedback may be obtained via one or more optical encoders or Hall effect sensors at a master/primary side of the actuation system (e.g., remote from the robotic hand), at a slave/secondary side of the actuation system (e.g., at the joint of the robotic finger), and/or a combination thereof. In some implementations, an actuator at the primary side (e.g., a master hydraulic cylinder) can be driven by a linear motor, lead screw, or piezoelectric motor for operating the actuation system and receiving the positional feedback.

In some implementations, the robotic hand may be configured like a human hand (e.g., a plurality of robotic fingers coupled with the base, such as four robotic fingers and a robotic thumb). The robotic hand may have dimensions that are in a range corresponding to dimensions of a human hand. In some implementations, the robotic hand (e.g., the base and the robotic fingers) may wear a sensing glove that includes a plurality of force sensors outwardly facing to detect forces in an environment. The sensing glove may be a same glove, or a same configured glove, as worn by a human user in a demonstration environment. For example, the sensing glove worn on the robotic hand could be a small, medium, or large glove that fits the hand of the user. In other implementations, the robotic hand may be configured as a pinch gripper. For example, the robotic hand may include the base and two robotic fingers for precisely controlled pinch gripping.

In some implementations, the actuation system may include one or more compliance devices. A compliance device may enable flexibility of a joint, such as when grasping an object. For example, this may be useful to prevent breakage when grasping a delicate object. Each compliance device may enable adjustment of a joint from a determined position in a range of motion of the joint. The compliance device can limit the adjustment to a subrange within the range of motion. For example, the compliance device may be a passive device that enables compliance of an actuator (e.g., a hydraulic or pneumatic actuator) in the system. This may enable the joint to have a limited motion in the circuit relative to the determined position. In some implementations, the amount of motion may be limited by an adjustable end stop. Additionally, an adjustable spring force may enable a force adjustment at the joint (e.g., stiffness control). In various implementations, the compliance device may utilize a piston, coil spring, diaphragm, bladder, electrical coil, ports, valves, and/or fluid (e.g., hydraulic or pneumatic). The compliance device could be in line with a fluid line to the actuator (e.g., a hydraulic or pneumatic line), or integrated with the actuator (e.g., a hydraulic or pneumatic actuator). As a result, compliance at a joint of the robotic finger 150 may be achieved for improved handling by the robotic hand.

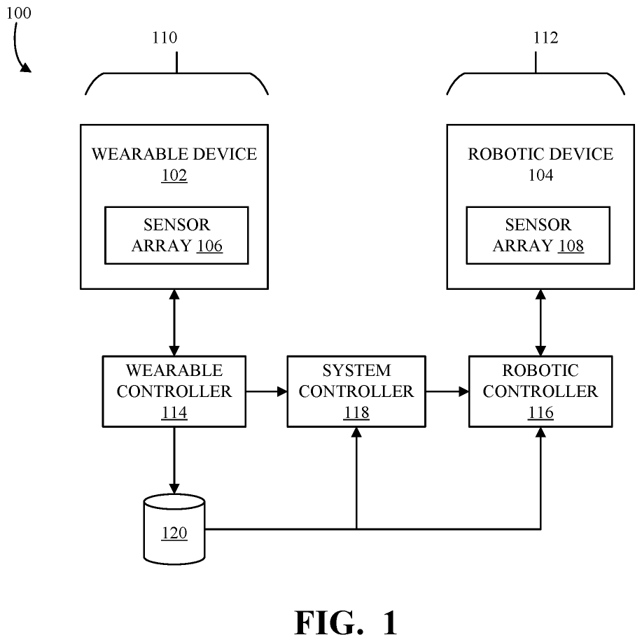

FIG. 1 is an example of a system 100 utilizing robotic fingers with actuating joints. The system 100 may include a wearable device 102, a robotic device 104, a wearable controller 114, a robotic controller 116, a system controller 118, and/or a data structure 120. The wearable controller 114 may include a sensor array 106, and the robotic device 104 may include a sensor array 108. The wearable device 102 may operate in a demonstration environment 110. For example, the wearable device 102 could comprise a sensing glove worn by a human user. The robotic environment 112 may operate in a robotic environment 112. The robotic environment 112 may include the robotic fingers with actuating joints. In some implementations, the robotic fingers may wear a sensing glove like the one worn by the human user.

In operation, the wearable controller 114 may obtain sensing information from the wearable device 102 via the sensor array 106 (e.g., tactile sensing). For example, the sensing information may be generated based on the human user performing a task with an object in the demonstration environment 110. The robotic controller 116 can control the robotic device 104, based on sensing information from the sensor array 108 (e.g., tactile sensing), to repeat the task in the robotic environment 112. In some cases, the system controller 118 may coordinate the control between the wearable controller 114 and the robotic controller 116. In some cases, tasks may be stored in the data structure 120 to enable the robotic controller 116 to control the robotic device 104 at different times (e.g., recorded playback).

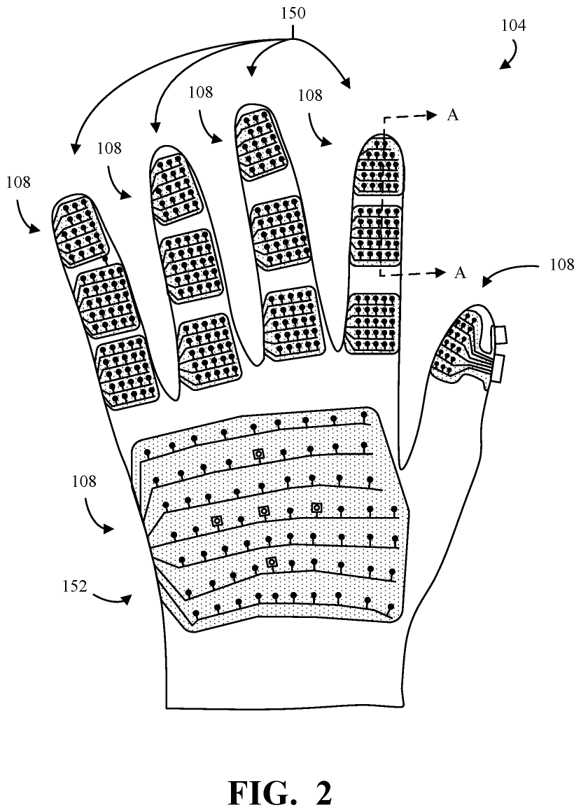

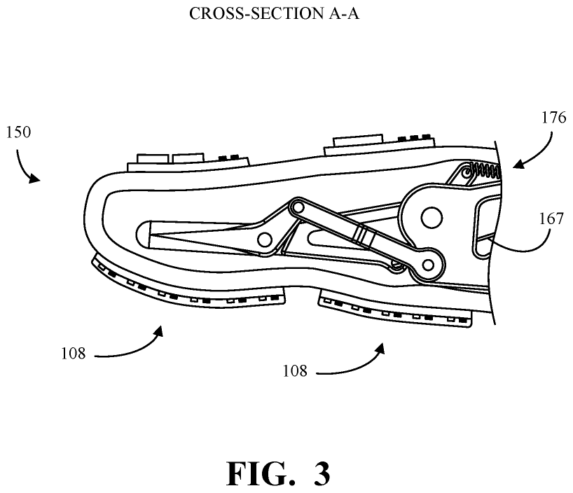

FIG. 2 is an example of robotic fingers 150 with tactile sensing. The robotic fingers 150 may be part of the robotic device 104. For example, the robotic device 104 may include a robotic hand coupled with the robotic fingers 150. The robotic hand may be wearing a wearable device with a sensor array, e.g., a sensing glove with the sensor array 108. The sensor array 108 may comprise a plurality of sensors, such as force sensors, motion sensors, proximity sensors, and/or cameras. The robotic fingers 150 may be coupled with a base 152. With additional reference to FIG. 3, a cross-section A-A of a portion of a robotic finger 150 of the robotic hand is shown by way of example.

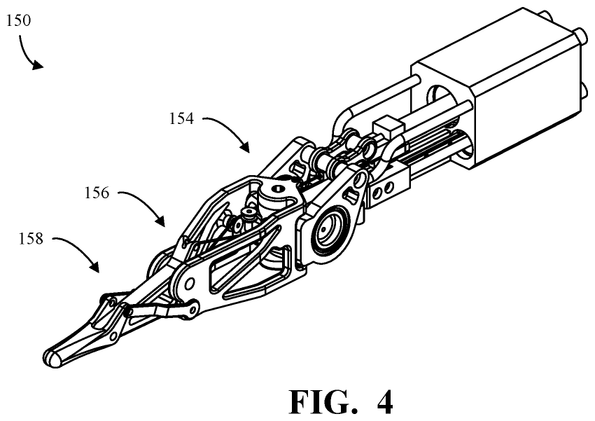

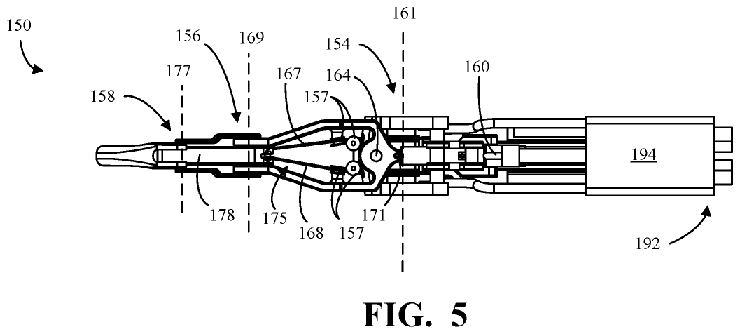

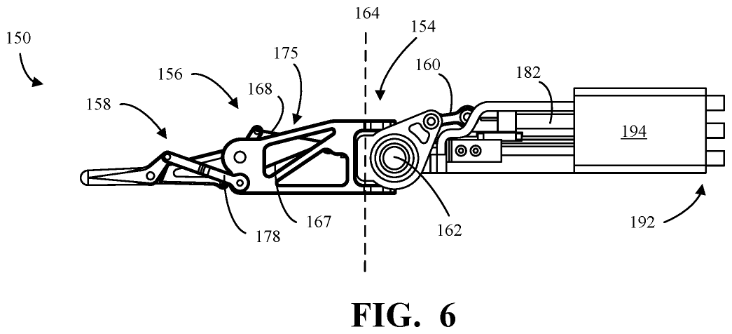

FIG. 4 is an isometric view of an example of the robotic finger 150. FIG. 5 is a top view of an example of the robotic finger 150. FIG. 6 is a side view of an example of the robotic finger 150. The robotic finger 150 may include a plurality of joints for performing complex motions consistent with motions of the human hand (an anthropomorphic robotic hand), such as a first joint 154 (e.g., an MCP joint), a second joint 156 (e.g., a PIP joint), and a third joint 158 (e.g., a DIP joint). Dimensions of the robotic finger 150, coupled with the base 152 of FIG. 2, may be in a range corresponding to dimensions of a human finger. For example, the robotic finger 150 could be configured to fit in a particular size glove made for a human hand, such as extra-small (XS), small(S), medium (M), large (L), or extra-large (XL). In some implementations, the robotic finger 150, coupled with the base 152, may be sized greater than the range corresponding to a human hand. This may enable a greater surface area with greater applications of torque or force at the joints for lifting and handling larger, heavier objects. In some implementations, the robotic finger 150, coupled with the base 152, may be sized less than the range corresponding to a human hand. This may enable a smaller surface area with less torque or force available at the joints, such as for gaining access to tight area, or fine handling of smaller, lighter objects.

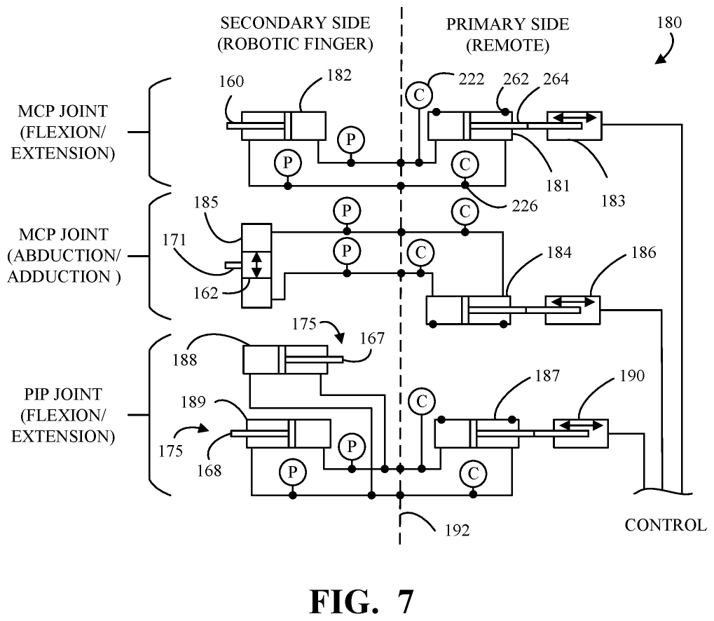

The system for the robotic hand may include the base 152 (e.g., the hand portion) coupled with one or more robotic fingers 150, such as two fingers of a pinch gripper, or four fingers and a robotic thumb as shown). With additional reference to FIG. 7, the system may also include an actuation system 180 that actuates the plurality of joints (e.g., the first joint 154, the second joint 156, and the third joint 158). For example, the actuation system 180 may comprise a hydraulic drive system. In other implementations, the actuation system 180 may comprise a pneumatic drive system, a piezoelectric drive system, a motor drive system, or combination of hydraulic, pneumatic, piezoelectric, and/or motor drive systems.

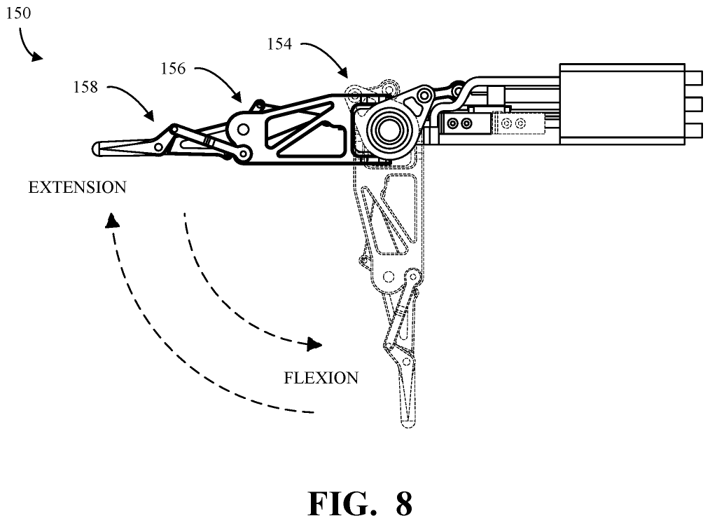

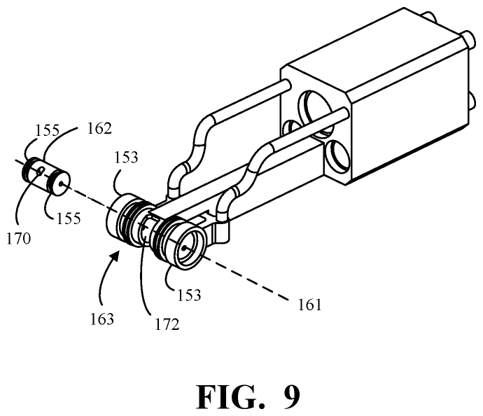

The actuation system 180 may be a closed system that includes a master/primary side (e.g., remote from the from the robotic finger or hand) and a slave/secondary side (e.g., implemented by the robotic finger). The actuation system 180 may include a first master actuator 181 (e.g., a master hydraulic cylinder including a piston) that drives a first connection 160 via a first slave actuator 182 (e.g., a slave hydraulic cylinder including a piston). The first connection 160 may be coupled with the first joint 154 (e.g., the MCP joint) and may comprise a linkage to push and pull the robotic finger 150 at the first joint 154 (e.g., dual acting) to a determined position. The first master actuator 181 may be remote from the robotic finger or hand, in the primary side of the system, and the first slave actuator 182 may be implemented by the robotic finger or hand in the secondary side of the system. A first control actuator 183 in the primary side, such as a linear motor, lead screw, or piezoelectric motor, may be controlled to drive the first master actuator 181. For example, the first control actuator 183 may be controlled by the robotic controller 116. Driving the first control actuator 183 in a first direction may cause the first master actuator 181 to transmit fluid to a first side of the first slave actuator 182 to push the first connection 160 in a first direction. For example, driving the fluid may cause a high pressure to be applied to the first side of the first slave actuator 182, and a low pressure on a second side of the first slave actuator 182. This results in driving the first connection 160 to cause a rotation of the robotic finger 150 about a first axis 161 by a determined amount, resulting flexion of the robotic finger 150 at the first joint 154 to a determined angle as shown in FIG. 8. With additional reference to FIG. 9, bearings of the robotic finger 150 may contact bearing surfaces 153 during the rotation about the first axis 161.

Driving the first control actuator 183 in a second direction may cause the first master actuator 181 to transmit fluid to a second side of the first slave actuator 182 to pull the first connection 160 in a second direction. For example, driving the fluid may cause a high pressure to be applied to the second side of the first slave actuator 182, and a low pressure on the first side of the first slave actuator 182. This results in driving the first connection 160 to cause a rotation of the robotic finger 150 about the first axis 161 in an opposite direction by a determined amount, resulting in extension of the robotic finger 150 at the first joint 154 to a determined angle as shown in FIG. 8. In some implementations, the flexion/extension rotation may have a range of motion of at least 45 degrees, and in some cases, at least 90 degrees (e.g., the robotic finger 150 may be driven at the first joint 154, up or down, to a determined position between 0 and 45 degrees, and in some cases, 0 to 90 degrees, or more).

The actuation system 180 may also include a second master actuator 184 (e.g., another master hydraulic cylinder including a piston) that drives a cylinder 162 (e.g., a center piece or plug, enclosed by an outer cylinder 163) from side to side via a second slave actuator 185 (e.g., another slave hydraulic cylinder including a piston). With additional reference to the cutaway view of FIG. 9, the cylinder 162 may be coupled with the first joint 154 (e.g., the MCP joint). The cylinder 162 may travel from side to side, along the first axis 161, within the outer cylinder 163 of the second slave actuator 185, to further drive the first joint 154 to a determined position. Additionally, the cylinder 162 may rotate freely (independently of other forces or constraints) about the first axis 161, within the outer cylinder 163, based on operation of the first master actuator 181 and the first slave actuator 182 (e.g., controlling the flexion/extension motions caused by the first connection 160). The cylinder 162 can travel from side to side within the inner diameter of the outer cylinder 163 in a piston actuation, and based on roundness, can rotate freely within the outer cylinder 163, in simultaneous actions. This may enable the actuation system 180 to drive the first connection 160 to cause flexion or extension at the first joint 154 independently of driving the cylinder 162 to cause adduction or abduction at the first joint 154. The second master actuator 184 may be remote from the robotic finger or hand, in the primary side, and the second slave actuator 185 may be implemented by the robotic finger or hand in the secondary side.

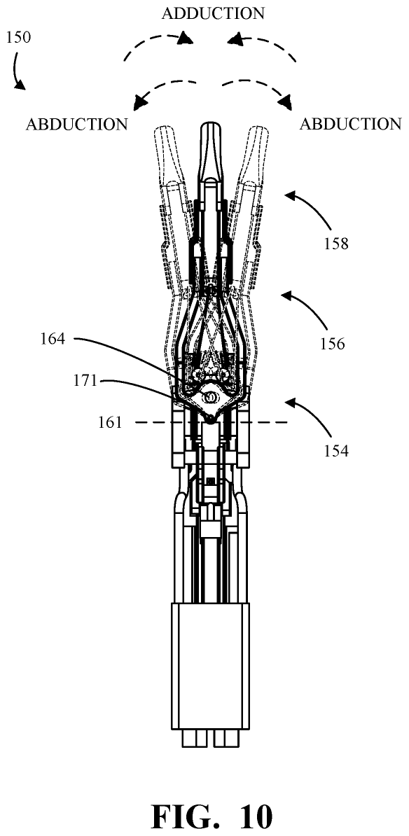

A second control actuator 186 in the primary side, such as a linear motor, lead screw, or piezoelectric motor, may be controlled to drive the second master actuator 184. For example, the second control actuator 186 may be controlled by the robotic controller 116. Driving the second control actuator 186 in a first direction may cause the second master actuator 184 to transmit fluid to a first side of the cylinder 162 (sealed within the outer cylinder 163, via seals 155 shown in FIG. 9). For example, driving the fluid may cause a high pressure to be applied to the first side of the cylinder 162, and a low pressure on a second side of the cylinder 162. This, in turn, pushes the cylinder 162 along the first axis 161 in a first direction. This causes a rotation of the robotic finger 150 about a second axis 164 by the determined amount as shown in FIG. 6, resulting in abduction or adduction of the robotic finger 150 at the first joint 154 (depending on the current position of the robotic finger) to a determined angle as shown in FIG. 10.

Driving the second control actuator 186 in a second direction may cause the second master actuator 184 to transmit fluid to a second side of the cylinder 162. For example, driving the fluid may cause a high pressure to be applied to the second side of the cylinder 162, and a low pressure on the first side of the cylinder 162. This, in turn, pushes the cylinder 162 along the first axis 161 in a second direction (e.g., an opposite direction). This causes a rotation of the robotic finger 150 about the second axis 164 in the second direction by a determined amount, resulting in abduction or adduction of the robotic finger 150 at the first joint 154 (depending on the current position of the robotic finger) to a determined angle in the opposite direction as shown in FIG. 10. In some implementations, the abduction/adduction rotation may have a range of motion of at least 10 degrees, and in some cases, at least 20 degrees (e.g., the robotic finger 150 may be driven at the first joint 154, to one side or the other, to a determined position between 0 and 10 degrees, and in some cases, 0 to 20 degrees, or more).

As shown in FIGS. 9 and 10, the cylinder 162 may include a slot 170 for receiving a pin 171 through an opening 172 of the outer cylinder 163. The pin 171, coupled with the cylinder 162, can move along the first axis 161 to cause the rotation of the robotic finger 150 about the second axis 164. The pin 171 can also rotate with the cylinder 162 along the first axis 161 following the rotation of the robotic finger 150 about the first axis 161.

Referring again to FIG. 7, the actuation system 180 may also include a third master actuator 187 (e.g., another master hydraulic cylinder including a piston) that drives a third connection 175 coupled with the second joint 156 (e.g., the PIP joint) via a slave actuator. For example, the third connection 175 may comprise a first tendon 167 driven via a first slave actuator 188 (e.g., a slave hydraulic cylinder including a piston) and a second tendon 168 driven via a second slave actuator 189 (e.g., another slave hydraulic cylinder including a piston). The first tendon 167 may be coupled with the second joint 156 (e.g., the PIP joint) as a first linkage to pull the robotic finger 150 in a first direction at the second joint 156 (e.g., single acting) to a determined position, such as pulling down to cause a flexion of the robotic finger 150 by a determined amount. The second tendon 168 may also be coupled with the second joint 156 as a second linkage to pull the robotic finger 150 in a second direction at the second joint 156 (e.g., single acting) to a determined position, such as pulling up to cause an extension of the robotic finger 150 by a determined amount. The first tendon 167 and the second tendon 168 may be routed through the robotic finger 150, for example, via guides 157 (e.g., pulleys) as shown in FIG. 5. The third master actuator 187 may be remote from the robotic finger or hand, in the primary side, and the first slave actuator 188 and the second slave actuator 189 may be implemented by the robotic finger or hand in the secondary side.

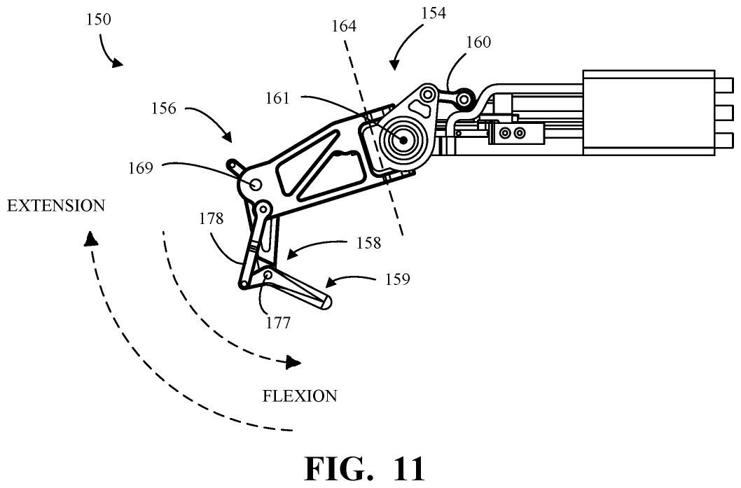

A third control actuator 190 in the primary side, such as a linear motor, lead screw, or piezoelectric motor, may be controlled to drive the third master actuator 187. For example, the third control actuator 190 may be controlled by the robotic controller 116. Driving the third control actuator 190 in a first direction may cause the third master actuator 187 to transmit fluid to a first side of the first slave actuator 188 to pull the first tendon 167 (and transmit fluid to a second side of the second slave actuator 189 to release the second tendon 168). For example, this may cause a high pressure to be applied to the first side of the first slave actuator 188 (and a low pressure on second sides of the first slave actuator 188 and the second slave actuator 189). This, in turn, pulls the first tendon 167 to cause a rotation of the robotic finger 150 about a third axis 169 by a determined amount as shown in FIG. 5. This can result in a flexion of the robotic finger 150 at the second joint 156 to a determined angle as shown in FIG. 11.

Driving the third control actuator 190 in a second direction may cause the third master actuator 187 to transmit fluid to a first side of the second slave actuator 189 to pull the second tendon 168 (and transmit fluid to a second side of the first slave actuator 188 to release the first tendon 167). For example, this may cause a high pressure to be applied to the first side of the second slave actuator 189 (and a low pressure on second sides of the second slave actuator 189 and the first slave actuator 188). This, in turn, pulls the second tendon 168 to cause a rotation of the robotic finger 150 about the third axis 169 by a determined amount in an opposite direction. This can result in extension of the robotic finger 150 at the second joint 156 to a determined angle as shown in FIG. 11. In some implementations, the flexion/extension rotation may have a range of motion of at least 45 degrees, and in some cases, at least 90 degrees (e.g., the robotic finger 150 may be driven at the second joint 156, up or down, to a determined position between 0 and 45 degrees, and in some cases, 0 to 90 degrees, or more).

In some implementations, one or more of the actuations may be single acting (e.g., pulling) with a spring return. For example, referring again to FIG. 3, in some implementations the third connection 175 may comprise the first tendon 167 (e.g., for single acting actuation in one direction, such as to pull) and a spring 176. Driving the third control actuator 190 in a first direction can cause the third master actuator 187 to transmit fluid to a first side of the first slave actuator 188 to pull the first tendon 167 (and stretch the spring 176). For example, driving the fluid may cause a rotation of the robotic finger 150 about the third axis 169 by a determined amount as shown in FIG. 5. Releasing the first tendon 167 (e.g., enabling fluid to escape from the first side of the first slave actuator 188) may enable the spring 176 to pull the robotic finger 150 in a second direction at the second joint 156. This may cause a rotation of the robotic finger 150 about the third axis 169 to a default position, such as a return to a full extension at the second joint 156.

Additionally, the third master actuator 187 driving the third connection 175 to the second joint 156 can cause another rotation of the robotic finger 150 about a fourth axis 177 at the third joint 158 (e.g., the DIP joint) as shown in FIG. 5. This may correspond to flexion or extension of the robotic finger 150 at the third joint 158, moving a robotic fingertip 159 of the robotic finger 150 up and down. The rotation at the at the third joint 158 may be caused by a fourth connection 178 between the second joint 156 and the third joint 158 as shown in FIG. 6.

As a result, robotic fingers 150 of the robotic hand can perform motions that are consistent with motions of a human fingers of the human hand, including abduction, adduction, flexion, and/or extension at various joints, and simultaneous combinations thereof. For example, the robotic finger 150 may enable the abduction/adduction motion and flexion/extension motion to be localized at the MCP joint (as opposed to abduction/adduction occurring halfway between the MCP joint and the PIP joint). The robotic finger 150 can perform such motions with at least three degrees of freedom (DOF), including at least two DOF of the first joint 154, and at least one DOF at the second joint 156. Further, based on targeted utilization of pressurized hydraulics, the robotic finger 150 can perform such motions with strength in a range of a human hand, such as for lifting a heavy object or grasping the object by pinching a finger and a thumb together (e.g., applying 10 to 20 Newtons of force) while enabling fine control of the object.

In some implementations, to facilitate maintenance and repair, the robotic finger 150 may be detachable from the base 152. For example, referring again to FIGS. 5-7, hydraulic lines of the actuation system 180 may be sealed at a plurality of valves 192 between the robotic finger 150 and the base 152 (e.g., between the primary side and the secondary side). The robotic finger 150 can then be detached from the base via decoupling of component 194 from the base 152. This may enable simplified maintenance and repair of the robotic finger 150 without replacing the entire robotic hand.

In some implementations, positional feedback may be obtained from the actuation system to determine the angles of rotation at the various joints. This may enable precise control of such angles by the robotic controller 116 via the actuation system 180. For example, referring again to FIG. 7, a position (e.g., the positional feedback) may be obtained via one or more position detection devices, such as an optical encoder or Hall effect sensor. The one or more position detection devices may be arranged at the primary side of the actuation system 180 (e.g., remote from the robotic finger or hand, such as coupling with a master actuator, like the first master actuator 181), at the secondary side of the actuation system 180 (e.g., at the joint of the robotic finger, such as coupling with a connection of the joint, like the first connection 160, the cylinder 162, the first tendon 167, or the second tendon 168), and/or a combination thereof. In some implementations, the control actuator (e.g., a linear motor, lead screw, or piezoelectric motor, such as the first control actuator 183) in the primary side may be utilized to determine the positional feedback based on movement of the actuator.

In some implementations, torque or force feedback may be obtained from the actuation system to determine the torque or force being applied at the various joints. This feedback may enable precise control of such forces by the robotic controller 116 via the actuation system 180. For example, referring again to FIG. 7, torque or force feedback may be obtained via pressure sensors (marked “P”) coupled with lines of the actuation system (e.g., hydraulic lines, or in some cases, pneumatic lines). A difference in pressure determined between two lines of an actuator (e.g., a slave actuator) may enable determining a torque or force being applied at a joint that is driven by the actuator.

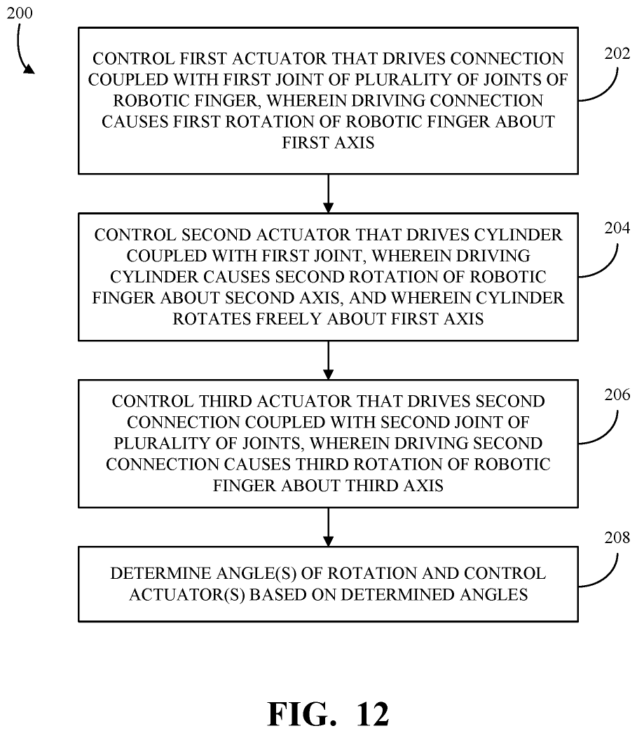

FIG. 12 is an example of a process 200 for operating robotic fingers with actuating joints. The process 200 can be executed using computing devices, such as the systems, hardware, and software described with respect to FIGS. 1-11. The process 200 can be performed, for example, by executing a machine-readable program or other computer-executable instructions, such as routines, instructions, programs, or other code. The operations of the process 200 or another technique, method, process, or algorithm described in connection with the implementations disclosed herein can be implemented directly in hardware, firmware, software executed by hardware, circuitry, or a combination thereof.

For simplicity of explanation, the process 200 is depicted and described herein as a series of operations. However, the operations in accordance with this disclosure can occur in various orders and/or concurrently. Additionally, other operations not presented and described herein may be used. Furthermore, not all illustrated operations may be required to implement a technique in accordance with the disclosed subject matter.

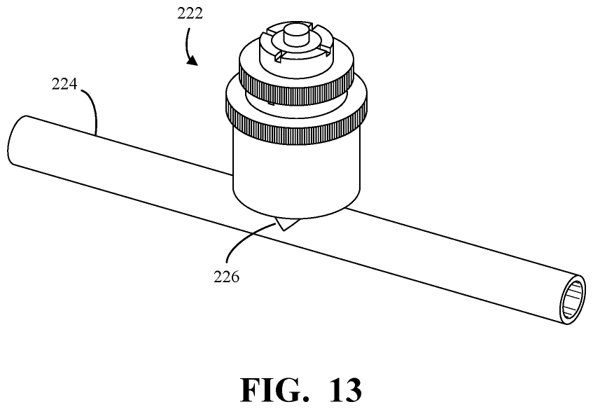

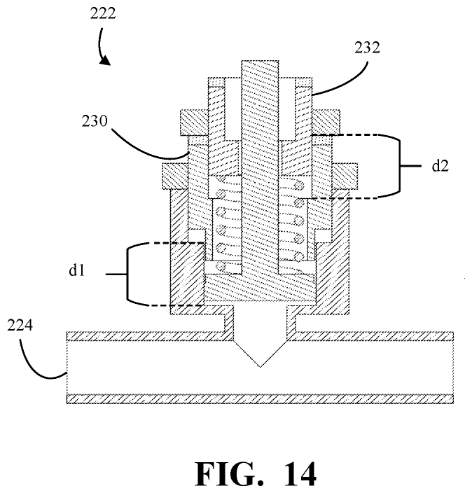

At operation 202, a system may control a first actuator that drives a connection coupled with a first joint of a plurality of joints of a robotic finger. Driving the connection can cause a first rotation of the robotic finger about a first axis (e.g., flexion/extension). For example, the actuation system 180, controlled by the robotic controller 116, may control the first master actuator 181 that drives the first connection 160 coupled with the first joint 154 (e.g., the MCP joint) of the robotic finger 150. Driving the first connection 160 can cause a first rotation of the robotic finger 150 about the first axis 161. In some implementations, one or more compliance devices (e.g., the compliance device 222 of FIGS. 13, 14, and/or 15) may be utilized to achieve flexion compliance and/or extension compliance at the first joint.

At operation 204, the system may control a second actuator that drives a cylinder coupled with the first joint. Driving the cylinder can cause a second rotation of the robotic finger about a second axis (e.g., abduction/adduction). The cylinder can rotate freely about the first axis. For example, the system may control the second master actuator 184 that drives the cylinder 162 coupled with the first joint 154 (e.g., the MCP joint). Driving the cylinder 162 can cause a second rotation of the robotic finger 150 about a second axis 164. The cylinder 162 can rotate freely about the first axis 161. In some implementations, one or more compliance devices may be utilized to achieve abduction compliance and/or adduction compliance at the second joint.

At operation 206, the system may control a third actuator that drives a second connection coupled with a second joint of the plurality of joints. Driving the second connection can cause a third rotation of the robotic finger about a third axis. Driving the second connection can further cause a fourth rotation of the robotic finger about a fourth axis corresponding to a third joint of the plurality of joints. For example, the system may control the third master actuator 187 that drives a second connection coupled with the second joint 156 (e.g., the PIP joint). In some implementations, the second connection may include one or more tendons that may be pulled, such as the first tendon 167 and the second tendon 168. In some implementations, the second connection may include a spring, such as the spring 176. Driving the second connection can cause a third rotation of the robotic finger 150 about a third axis 169. Driving the second connection can further cause a fourth rotation of the robotic finger 150 about the fourth axis 177 corresponding to the third joint 158 (e.g., flexion or extension of the robotic finger at a DIP joint, such as moving a robotic fingertip up and down). In some implementations, one or more compliance devices may be utilized to achieve flexion compliance and/or extension compliance at the second joint and/or the third joint.

At operation 208, the system may determine one or more angles of rotation (e.g., angles of the first rotation, the second rotation, the third rotation, and/or the fourth rotation) and control actuators (e.g., the first actuator, the second actuator, and/or the third actuator) based on the determined angles. For example, via the actuation system 180, the robotic controller 116 may determine angles of rotation of the robotic finger 150, such as an angle of the first rotation, an angle of the second rotation, an angle of the third rotation, and/or an angle of the fourth rotation. The robotic controller 116 can then control the actuators (e.g., the first master actuator 181, the second master actuator 184, and/or the third master actuator 187, via the first control actuator 183, the second control actuator 186, and/or the third control actuator 190, respectively) based on the determined angles. This may enable the performance of complex motions of the robotic hand.

In some implementations, the actuation system 180 may include one or more compliance devices 222. FIG. 13 is an isometric view of an example of a compliance device 222 for the robotic finger 150. FIG. 14 is a cutaway view of the example of the compliance device 222. Referring also to FIG. 7, the actuation system 180 may include one or more compliance devices 222 (marked “C” in FIG. 7) for one or more joints of robotic fingers 150 of the robotic hand. The compliance device 222 may enable flexibility of a joint (e.g., the MCP, PIP, or DIP joint), such as when grasping an object (e.g., compliance, or shock abatement). For example, this may be useful to prevent breakage when grasping a delicate object. Each compliance device 222 may enable adjustment of a joint from a determined position in a range of motion of the joint. The compliance device 222 can limit the adjustment to a subrange within the range of motion. For example, the compliance device 222 may be a passive device that enables compliance of an actuator (e.g., a hydraulic or pneumatic actuator) in the system. This may enable the joint to have a limited motion in the circuit relative to the determined position. In some implementations, the amount of motion may be limited by an adjustable end stop 230 (adjustable through a distance “d1” that defines the subrange). Additionally, an adjustable spring force 232 may enable a force adjustment at the joint (e.g., stiffness control, adjustable through a distance “d2” that defines the stiffness).

As a result, the compliance device 222 may enable adjustment of a joint from a determined position in a range of motion of the joint. For example, when implemented with respect to the first joint 154, the compliance device 222 may enable adjustment of the first joint 154 from a determined position within the range of 0 and 45 degrees, and in some cases, 0 to 90 degrees, or more, associated with flexion/extension of the first joint 154. Additionally, the compliance device can limit the adjustment to a subrange within the range of motion. For example, the compliance device can limit the adjustment of the first joint 154 from the determined position to a subrange of 0 to 10 degrees in a first direction (e.g., the flexion direction from the determined position). Further, a second compliance device can limit the adjustment of the first joint 154 from the determined position to a subrange of 0 to 10 degrees in a second direction (e.g., the extension direction from the determined position). In some cases, a single compliance device 222 may be utilized for a given joint to achieve compliance in a single direction (e.g., a preferred direction, such as the extension direction to achieve compliance when grasping an object). In other cases, a pair of compliance devices 222 may be utilized for a given joint to achieve compliance in two directions (e.g., the flexion and extension directions).

In some implementations, the compliance device 222 may be coupled with a fluid line 224 (e.g., in line with a hydraulic or pneumatic line) that is coupled with an actuator (e.g., a side of the first master actuator 181, the second master actuator 184, or the third master actuator 187, in the primary side). The fluid line 224 may include a port 226 to couple with the compliance device 222 which may be opened when the compliance device 222 is present. The port 226 may be closed to seal the fluid line 224 when the compliance device 222 is not present. Referring also to FIG. 7, multiple ports 226 may be implemented by fluid lines in the primary side, including fluid lines coupled with the first master actuator 181, the second master actuator 184, and the third master actuator 187 (e.g., the ports of the fluid lines are coupled with compliance devices marked “C” in FIG. 7). Utilizing ports that may be selectively sealed enables flexibility and strategic placement of the compliance devices in the actuation system 180. Further, the compliance device 222 may be placed in the primary side (where space may be abundant), as opposed to the secondary side (where space may be limited), based on the primary side being coupled with the secondary side. Actions in the primary side may be duplicated by actions in the secondary side based on the movement of incompressible hydraulic fluid in the closed system. For example, actions of a master actuator in the actuation system 180 (which may be caused by a control actuator) may cause a slave actuator to drive the first connection 160, the cylinder 162, the first tendon 167, or the second tendon 168.

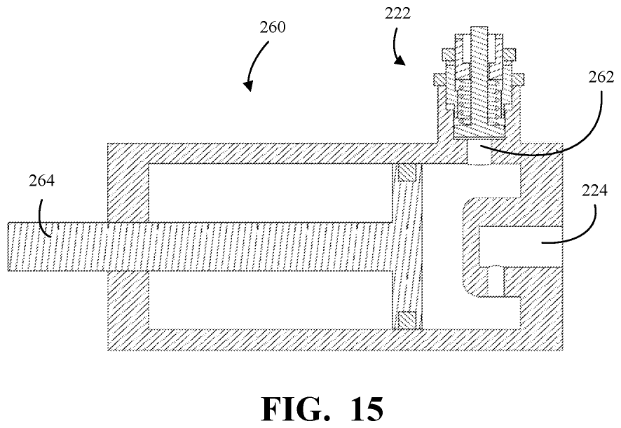

In some implementations, the compliance device 222 may be coupled with an actuator (e.g., integrated with the cylinder of a hydraulic or pneumatic actuator) that is coupled with the fluid line 224. FIG. 15 is a cutaway view of an example of the compliance device 222 integrated with an actuator 260 (e.g., the first master actuator 181, the second master actuator 184, or the third master actuator 187, in the primary side). The actuator 260 may be controlled by a control actuator in in the actuation system 180 via a piston 264 (e.g., controlled by the first control actuator 183, the second control actuator 186, or the third control actuator 190). The actuator 260 may include a port 262 on one or both sides to couple with the compliance device 222. The port 262 may be opened when the compliance device 222 is present. The port 262 may be closed to seal the actuator 260 when the compliance device 222 is not present. Referring also to FIG. 7, multiple ports 262 may be implemented by actuators in the primary side, including sides of the first master actuator 181, the second master actuator 184, and the third master actuator 187 (e.g., the ports of the actuators are sealed in FIG. 7). As a result, compliance at a joint (e.g., in a hydraulic system) may be achieved for improved handling by the robotic hand.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function. While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system for a robotic finger, comprising:
a base coupled with a robotic finger including a plurality of joints; and
an actuation system that actuates the plurality of joints, the actuation system including:
a first actuator that drives a connection coupled with a first joint of the plurality of joints, wherein driving the connection causes a first rotation of the robotic finger about a first axis; and
a second actuator that drives a cylinder coupled with the first joint, wherein driving the cylinder causes a second rotation of the robotic finger about a second axis, and wherein the cylinder rotates freely about the first axis.

2. The system of claim 1, wherein a pin coupled with a slot of the cylinder moves along the first axis to cause the second rotation.

3. The system of claim 1, wherein the actuation system drives the connection to cause flexion or extension at the first joint independently of driving the cylinder to cause adduction or abduction at the first joint.

4. The system of claim 1, wherein the actuation system includes:
a primary side and a secondary side in a closed system, wherein actions in the primary side are duplicated by actions in the secondary side to drive the connection and drive the cylinder.

5. The system of claim 1, wherein the actuation system includes:
a third actuator that drives a second connection coupled with a second joint of the plurality of joints, wherein driving the second connection causes a third rotation of the robotic finger about a third axis.

6. The system of claim 5, wherein the connection comprises a linkage to push and pull, and wherein the second connection comprises one or more tendons to pull.

7. The system of claim 5, wherein the connection comprises a linkage to push and pull, and wherein the second connection comprises a spring.

8. The system of claim 5, wherein driving the second connection further causes a fourth rotation of the robotic finger about a fourth axis corresponding to a third joint of the plurality of joints.

9. The system of claim 1, wherein the robotic finger is detachable from the base based on sealing a plurality of valves between the robotic finger and the base.

10. The system of claim 1, wherein dimensions of the robotic finger are in a range corresponding to dimensions of a human finger.

11. The system of claim 1, wherein the robotic finger has at least three degrees of freedom (DOF) including at least two DOF of the first joint.

12. The system of claim 1, wherein the plurality of joints includes a metacarpophalangeal (MCP) joint, a proximal interphalangeal (PIP) joint, and a distal interphalangeal (DIP) joint, and wherein the first joint corresponds to the MCP joint.

13. The system of claim 1, wherein the actuation system comprises a hydraulic, pneumatic, piezoelectric, or motor drive system.

14. The system of claim 1, wherein the robotic finger is one of a plurality of robotic fingers coupled with the base forming a pinch gripper or robotic hand.

15. The system of claim 1, wherein the first rotation has a range of motion of at least 45 degrees, and wherein the second rotation has a range of motion of at least 10 degrees.

16. The system of claim 1, wherein the actuation system includes:
a compliance device that enables adjustment of the first joint from a determined position, wherein the compliance device limits the adjustment to a subrange within a range of motion of the first joint.

17. The system of claim 1, wherein the actuation system includes:
a compliance device that enables adjustment of the first joint from a determined position, wherein the compliance device limits the adjustment to a subrange within a range of motion of the first joint.

18. The system of claim 17, wherein the compliance device is coupled with a fluid line that is coupled with the first actuator.

19. The system of claim 17, wherein the compliance device includes an adjustable end stop that defines the subrange and an adjustable spring force that opposes the adjustment from the determined position.

20. A method for operating a robotic finger, comprising:
controlling a first actuator that drives a connection coupled with a first joint of a plurality of joints of a robotic finger, wherein driving the connection causes a first rotation of the robotic finger about a first axis; and
controlling a second actuator that drives a cylinder coupled with the first joint, wherein driving the cylinder causes a second rotation of the robotic finger about a second axis, and wherein the cylinder rotates freely about the first axis.

21. The method of claim 20, further comprising:
controlling a third actuator that drives a second connection coupled with a second joint of the plurality of joints, wherein driving the second connection causes a third rotation of the robotic finger about a third axis.

22. The method of claim 21, wherein driving the second connection further causes a fourth rotation of the robotic finger about a fourth axis corresponding to a third joint of the plurality of joints.

23. The method of claim 20, wherein actions in a primary side are duplicated by actions in a secondary side to driving the connection and driving the cylinder.

24. The method of claim 20, wherein high pressure applied to one side of the first actuator causes low pressure on another side of the first actuator to drive the connection in a first direction, and wherein high pressure applied to one side of the cylinder causes low pressure on another side of the cylinder to drive the cylinder in a first direction.

25. The method of claim 20, further comprising:
determining movement of a linear motor or lead screw to determine an angle of the first rotation or the second rotation.

26. The method of claim 20, wherein the first actuator is a first slave actuator coupled with a first master actuator via fluid lines, and wherein the second actuator is a second slave actuator coupled with a second master actuator via fluid lines.

27. The method of claim 20, further comprising:
determining movement of a master actuator controlling pressure in a line to determine an angle of the first rotation or the second rotation, respectively.

28. The method of claim 20, further comprising:
determining an angle of the first rotation based on a position of the connection, and an angle of the second rotation based on a position of the cylinder.

29. The method of claim 20, further comprising:
determining pressure in lines to the first actuator or the second actuator to determine torque or force applied at the first joint.

30. The method of claim 20, further comprising:
adjusting, via a compliance device, the first joint from a determined position, wherein the adjusting is limited to a subrange within a range of motion of the first joint.
